(19) United States
(12) Patent Application Publication
(10) Pub. No.: US 2009/0127088 A1
(43) Pub. Date: May 21, 2009

(54) Electronic Pressure Switch with Possibility of Quick Set-Up of the Main Operation Parameters

(75) Inventor: Adriana Sartor, Milan (IT)

Correspondence Address: AKERMAN SENTERFITT, P.O. BOX 3188, WEST PALM BEACH, FL, 33402-3188, US

(73) Assignee: Elettrotec s.r.l., Milano (IT)

(21) Appl. No.: 11/719,694

(22) PCT Filed: Nov. 22, 2005
(86) PCT No.: PCT/EP2005/056155

§ 371 Date: May 18, 2007

(30) Foreign Application Priority Data
Dec. 3, 2004 (IT) MI2004A002329

(51) Int. Cl. H01H 35/38

(52) U.S. Cl. 200/82 R

(57) ABSTRACT

An electronic pressure switch is described comprising an external body (1) provided with a cavity (60), a removable head (6) provided with means (7) for the tight closing of said body (1), a pressure sensor (8) exposed to the pressure of the environment under control, a circuit card (2) provided with memory connected with said pressure sensor (8) and set-up means (4) operating on said circuit card (2). Set-up means (4) are housed in said cavity (60) and comprise at least one key (12-13) reachable by the operator by removing said removable head (6).

The present invention concerns an electronic pressure switch with possibility of quick set-up of the main operation parameters.

There are known compact electronic pressure switches comprising internal printed circuits on which the operator can operate by means of set-up means.

In the circuit card a memory is usually present on which the fundamental utilisation parameters are recorded.

Very important are the actuation value and the de-actuation value (hysteresis) of the pressure switch.

Said values depend on the use of the pressure switch which therefore is made without any pre-set value.

The user decides which values to input.

The known pressure switches are usually made up of a hollow body within which a circuit card which controls its operation and a pressure sensor are housed.

In some cases said pressure switches have serial ports externally which are connectable to external personal computers which can opportunely set-up the pressure switches according to the user's desires.

This set-up method is however rather laborious and in any case it requires the availability of a computer. In addition the serial port, when the pressure switch is working, can be subject to damages caused by losses of liquids or powders of the machines to which it is applied. Consequently there is a fast wear of the pressure switch which must frequently be controlled and possibly replaced.

In any case the pressure switch must have rather limited dimensions in order to be easily applied on machines with limited space available.

There are also known pressure switches having integrated set-up means, which do not need any connection to a personal computer. However said set-up means are external to the body of the pressure switch and therefore they have the same problem of premature wear as found in the pressure switches previously described.

Finally, the know electronic pressure switches settable without the use of any personal computer are either with “normally open contact” or with “normally closed contact”. Therefore in order to have both functions it is necessary to buy two different pressure switches or to completely disassemble the pressure switch, to look for the serial port and to connect it to the personal computer.

Scope of the present invention is to provide a compact electronic pressure switch provided with integrated set-up means which allow a fast set-point adjustment of the main operation parameters and which are not directly exposed to external wearing agents.

According to the invention such scope is attained with an electronic pressure switch comprising an external body provided with a cavity, a removable head provided with means for tight closing of said body, a pressure sensor exposed to the pressure of the environment under control, a circuit card provided with memory connected with said pressure sensor and set-up means operating on said circuit cards, characterised in that said set-up means are housed in said cavity and comprise at least one key reachable by the operator by removing said removable head.

The set-up means are therefore protected and at the same time easily reachable.

The characteristics and the advantages of the present invention will become more evident from the following detailed description an embodiment thereof which will be illustrated as a non limiting example in the enclosed drawings, in which:

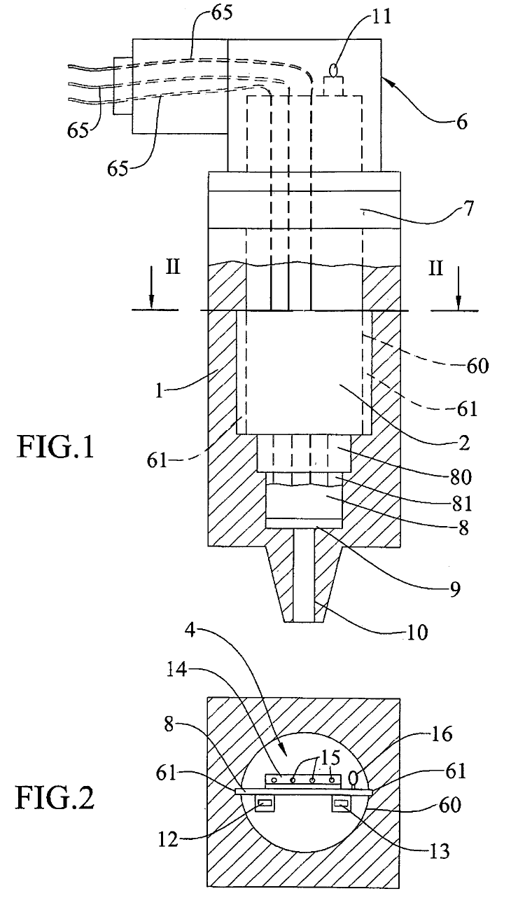

FIG. 1 shows a partially sectioned side view of a pressure switch according to the present invention;

FIG. 2 shows a section view according to the line II-II in FIG. 1;

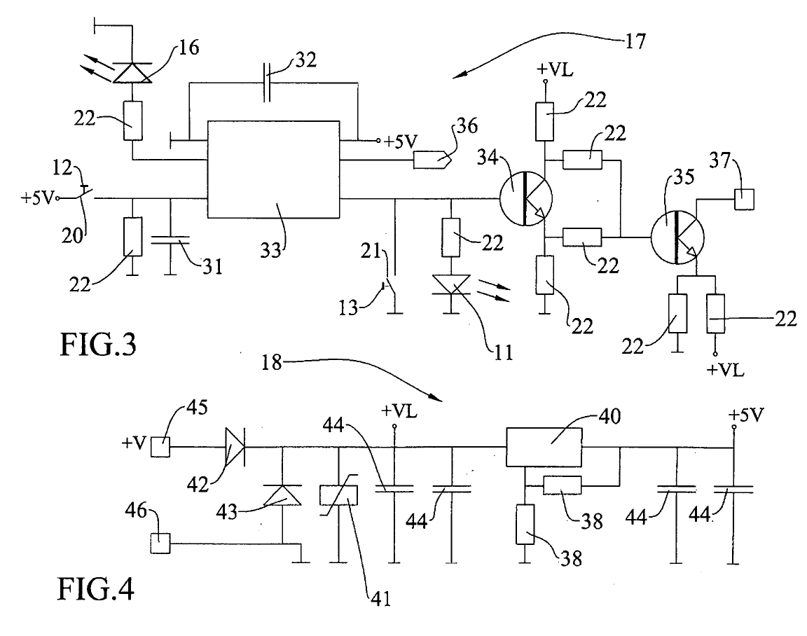

FIG. 3 shows the main part of the circuit cards of said pressure switch;

FIG. 4 shows a feeding and protection circuit comprised in said circuit card;

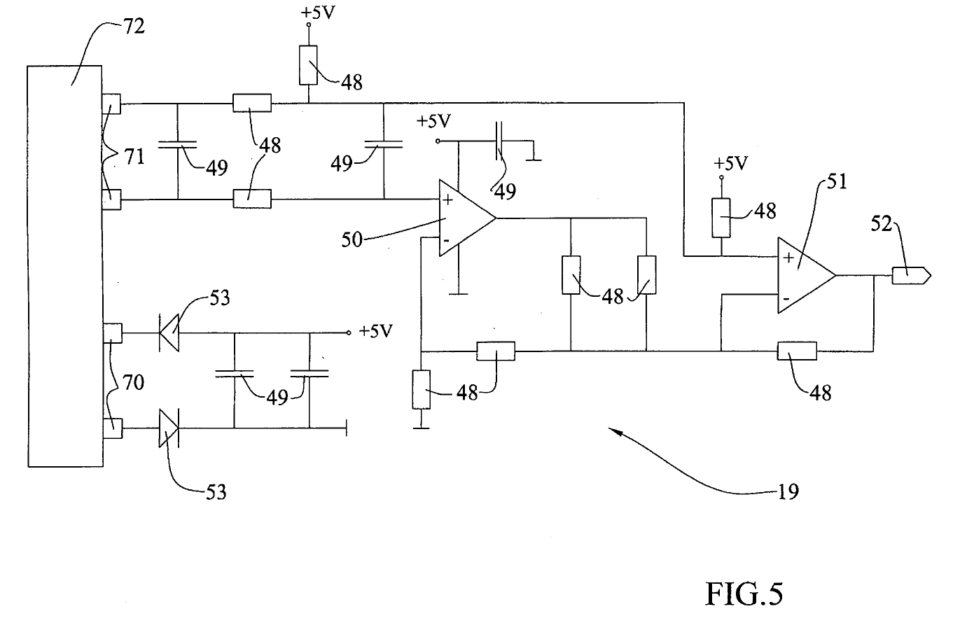

FIG. 5 shows a circuit of amplification of the pressure signal provided by the pressure sensor.

The electronic pressure switch shown in FIGS. 1 and 2 comprises an external body 1 with a cylindrical cavity 60 having a pair of longitudinal grooves 61 engageable in removable way with the ends of a flat extractable circuit card 2. At the top of the body 1 a removable transparent head 6 provided with a removable plate 7 is fastened for the tight closing of the cavity 60. Inside the head 6 a luminous signalling LED 11 capable to emit visible red light through the transparent head 6 is placed. The latter in addition is passed through by electric wires 65 for the external electric connection of the circuit card 2.

In the bottom part of the body 1 a ceramic pellet pressure sensor 8 with relative packing 9 is fastened by means of a metal ring 80 and a spacer 81, under which a channel 10 for the inlet of the controlled fluid is found.

The circuit card 2 bears set-up means 4 comprising set-up keys 12-13, a signalling luminous LED 16 emitting green colour light, and a serial port 14 provided with connecting feet 15 for the connection through the wires 65 to an external personal computer or other means for the input/collection of data. From a circuital point of view, said card 2 comprises a main circuit 17 (FIG. 3), a feeding and protection circuit 18 (FIG. 4) and a circuit 19 for the amplification of signals coming from the pressure sensor 8 (FIG. 5).

The main circuit 17 comprises switches 20-21 respectively controlled by the set-up keys 12-13, a microprocessor 33 with internal E²PROM memory and feedback condenser 32, a switching transistor 34, a power transistor 35, LEDs 11 and 16, several resistances 22, stabilization condensers 31, several ground connections, an inlet 36 and an outlet 37.

The feeding and protection circuit 18 comprises a pair of inlet terminals 45-46, diode valves 42-43 for the protection against tension reversals, a variable resistance 41, a voltage converter-stabilizer 40, resistances 38, condensers 44 and several ground connections.

Finally the amplification circuit 19 comprises inlet terminals 70 and outlet terminals 71 for a Wheatstone's bridge 72 of which the ceramics pellet 8 is a part, two operational amplifiers 50 and 51, an outlet 52 connected with the inlet 36 of the circuit part 17 of FIG. 3, diode valves 53, and several ground connections.

The manual set-up of the pressure switch is rather simple.

Let's consider the pressure switch mounted on the system or machine under control with the actuation pressure (for example 7 bar) at the desired regimen value. Such pressure is detected by the ceramic sensor 8, which determines an unbalance of the Wheatstone's bridge 72 which causes an electric signal with amplitude corresponding to the detected pressure, present at the outlet 52 of the amplification circuit 19 in FIG. 5 and at the inlet 36 of the microprocessor 33 of the circuit part 17 in FIG. 3.

In order to have access to the set-up keys 12-13 the head 6 and the plate 7, which are fastened to the hollow block 1 by means of simple removable connection (for example screw-nut), must be removed.

By keeping the black key 12 pressed for at least three seconds the value of pressure at the inlet 36 is acquired as actuation value by the memory of microprocessor 33, with consequent luminous confirmation signal of the green LED 16.

Each acquisition of a new actuation value also automatically sets up the de-actuation threshold (hysteresis) according to a minimum hysteresis value.

In order to set-up a different de-actuation threshold it is necessary to take the system to the desired de-actuation pressure and then to keep the white key 13 pressed for at least three seconds. In this case too the green LED 16 lights up in order to confirm the acquisition of the de-actuation value by the microprocessor 33 and relative memory.

Once the pressure switch has been set, it is possible to reassemble the body 1 with the plate 7 and the head 6.

During operation the luminous red LED 41, placed on the top of the pressure switch, turns on in order to indicate actuation steps and it is turned off in order to indicate the de-actuation ones. The transistors 34 and 35 get in turn commuted by the microprocessor 33 either in saturation or in interdiction in order to electrically signal to the outside, through the wires 65, either the state of actuation or de-actuation of the pressure switch.

In case it would be necessary to program the instrument again it is simply necessary to repeat the aforesaid procedure with different pressure values.

Before the acquisition of a new value (actuation or de-actuation) a test on the E²PROM memory is performed. This verification is signalled by a series of flashes of the green LED 16 in fast sequence before the visual signal of acquisition.

In addition to a remarkable rapidity of set-point adjustment, said pressure switch is very flexible since there is the possibility, by simultaneously pressing the keys 12-13 for a few second, to transform an operation modality with “normally opened” contact (that is with outlet 37 in FIG. 3 normally without signal) into an operation modality with “normally closed” contact (that is with outlet 37 normally with signal). In practice there are two pressure switches in one.

More precisely, the ceramic pellet 8 detects the pressure of operation of the system and, if this exceeds the actuation value, it creates a loss of balance of the Wheatstone's bridge 72 in FIG. 5 with consequent application, through the outlet 52 in FIG. 5 and the inlet 36 in FIG. 3, of a pressure signal to the microprocessor 33. The latter controls then the interdiction of the transistor 34, which in turn takes in interdiction the power transistor 35. The red LED 11 gets lit under control by the diode 41.

The card 2 is in addition provided with a protection circuit 18 for possible short circuits and wrong electric connections.

An opposite behaviour, with saturation of the transistors 34 and 35 and extinction of the red LED 11, is determined by the return of the pressure under the de-actuation threshold.

The pressure switch according to the present invention allows therefore to work in the maximum safety, to quickly set-up the fundamental operation parameters and to prevent frequent maintenance operations.

1. An electronic pressure switch comprising:
an external body provided with a cavity;
a removable head provided with means for tight closing of said body;
a pressure sensor exposed to the pressure of the environment under control;
a circuit card provided with memory connected with said pressure sensor; and
set-up means operating on said circuit card,
wherein said set-up means are housed in said cavity and comprises at least one key reachable by the operator by removing said removable head.

2. Electronic pressure switch according to claim 1, wherein said cavity has longitudinal grooves engageable with the ends of the circuit cards.

3. Electronic pressure switch according to claim 1, wherein said set-up means comprise a first key for the set0up of the actuation value and a second key for the set-up of the de-actuation value.

4. Electronic pressure switch according to claim 1, further comprising a luminous LED for signaling the set-up of the actuation value and the de-actuation value.

5. Electronic pressure switch according to claim 1, further comprising a huminous LED for signalling the state of intervention.

6. Electronic pressure switch according to claim 1, wherein said pressure sensor is a ceramic pellet.

7. Electronic pressure switch according to claim 6, wherein said ceramics pellet is inserted in a Wheatstone's bridge so as to determine its unbalance and the emission of signals when the pressure in the environment under control exceeds the actuation value.

8. Electronic pressure switch according to claim 7, wherein said circuit card comprises a microprocessor provided with memory, that receives signals of the Wheatstone bridge and determines accordingly the presence or not of output signals, said set-up means operating on the microprocessor in order to store the values of the signals of the Wheatstone's bridge which represent the values of actuation and de-actuation of the pressure switch.
